(19) United States
(12) Patent Application Publication
(10) Pub. No.: US 2020/0252013 A1
(43) Pub. Date: Aug. 6, 2020

(54) POWER GENERATION FACILITY EVALUATING DEVICE, POWER GENERATION FACILITY EVALUATING SYSTEM, POWER GENERATION FACILITY EVALUATING METHOD, AND COMPUTER PROGRAM PRODUCT

(71) Applicant: MITSUBISHI HEAVY INDUSTRIES, LTD., Tokyo (JP)

(72) Inventors: Hisaki YAMAUCHI, Tokyo (JP); Nobuyoshi TANAKA, Tokyo (JP); Hikaru YAMADA, Tokyo (JP)

(21) Appl. No.: 16/774,608

(22) Filed: Jan. 28, 2020

(30) Foreign Application Priority Data
Feb. 6, 2019 (JP) 2019-020071

(51) Int. Cl. H02P 9/00; H02P 9/04; G05B 13/04

(52) U.S. Cl. CPC H02P 9/006; G05B 13/042; H02P 9/04

(57) ABSTRACT

An evaluating method includes: obtaining a calculation formula used for calculating a flexibility index indicating operational flexibility in response to a demand for electric power, while using, as variables, a plurality of types of reference parameters which are parameters regarding flexibility capabilities of a power generation facility having impact on the operational flexibility in response to the demand; obtaining a reference parameter value of each of the reference parameters with respect to a power generation facility subject to an evaluation; calculating the flexibility index of the power generation facility subject to the evaluation, by inputting the obtained reference parameter values to the calculation formula; and evaluating the operational flexibility of the power generation facility subject to the evaluation, based on the calculated flexibility index, wherein the calculation formula is set such that weights applied with respect to the flexibility index are different in correspondence with the types of reference parameters.

### CROSS-REFERENCE TO RELATED APPLICATIONS

The present application claims priority to and incorporates by reference the entire contents of Japanese Patent Application No. 2019-020071 filed in Japan on Feb. 6, 2019.

### FIELD

The present invention relates to a power generation facility evaluating device, a power generation facility evaluating system, a power generation facility evaluating method, and a computer program product.

### BACKGROUND

In recent years, electric power generation facilities (hereinafter, simply “power generation facilities”) which use renewable energy and of which the amount of supplied electric power (hereinafter, “power supply amount”) is variable have been widely used. When such a power generation facility is connected to a system, there is a possibility that the voltage, the frequency, and the like of the system may fluctuate. Accordingly, to ensure stability of the system by suppressing such fluctuation, there is a need for power generation facilities having operational flexibility in response to a demand for electric power. Patent Literature 1 discloses suppressing frequency imbalance within a system, on the basis of detection values regarding amounts of change in electric power.

### CITATION LIST

### Patent Literature

Patent Literature 1: U.S. Pat. No. 10,074,983

### SUMMARY

### Technical Problem

The operational flexibility in response to a demand for electric power changes according to various capabilities of power generation facilities. It is therefore difficult to accurately evaluate how much operational flexibility each power generation facility has. For example, although the amounts of change in the electric power are detected in Patent Literature 1, there is a possibility that it may be impossible to accurately evaluate the operational flexibility from the amounts of change in the electric power alone. Accordingly, there is a need for properly evaluating the operational flexibility in response to a demand for electric power.

To solve the problem described above, it is an object of the present disclosure to provide a power generation facility evaluating device, a power generation facility evaluating system, a power generation facility evaluating method, and a computer program product that are capable of properly evaluating the operational flexibility of a power generation facility in response to a demand for electric power.

### Solution to Problem

To solve the problems described above and achieve the object, a power generation facility evaluating device includes: a calculation formula obtaining unit that obtains a calculation formula used for calculating a flexibility index indicating operational flexibility in response to a demand for electric power, while using, as variables, a plurality of types of reference parameters which are parameters regarding flexibility capabilities of a power generation facility having impact on the operational flexibility in response to the demand for the electric power; a parameter value obtaining unit that obtains a reference parameter value of each of the reference parameters with respect to a power generation facility subject to an evaluation; an index calculating unit that calculates the flexibility index of the power generation facility subject to the evaluation, by inputting the reference parameter values obtained by the parameter value obtaining unit to the calculation formula; and a flexibility evaluating unit that evaluates the operational flexibility of the power generation facility subject to the evaluation, on a basis of the calculated flexibility index, wherein the calculation formula obtaining unit obtains the calculation formula set in such a manner that weights applied with respect to the flexibility index are different in correspondence with the types of reference parameters.

The evaluating device described above is configured to make the evaluation on the basis of the flexibility index calculated as a quantitative value that comprehensively takes into account the capabilities having impact on the operational flexibility. It is therefore possible to properly evaluate the operational flexibility in response to a demand for electric power.

It is preferable that the calculation formula obtaining unit obtains the calculation formula in which parameters relevant to a fluctuation speed of supplied electric power are used as the plurality of types of reference parameters, while a largest weight is applied to such a parameter among the plurality of types of reference parameters that has highest relevance to the fluctuation speed of the supplied electric power. By using the evaluating device, it is possible to properly evaluate the operational flexibility in response to a demand for electric power.

It is preferable that the power generation facility evaluating device, includes: a contribution degree obtaining unit that obtains a first contribution degree which indicates a degree of contribution to stabilization of a system and is assigned to a power supply amount per unit time period; a reference parameter group obtaining unit that obtains a plurality of reference parameter groups each containing setting values of the plurality of types of the reference parameters; a power supply amount calculating unit that calculates, for each of the reference parameter groups, a power supply amount of a predetermined power generation facility in each time period, by performing an analysis on a basis of the reference parameter groups and the first contribution degree; and a contribution degree calculating unit that calculates, for each of the reference parameter groups, a second contribution degree indicating a degree of contribution made by the predetermined power generation facility to the stabilization of the system, on a basis of the power supply amount of the predetermined power generation facility in each time period, wherein the calculation formula obtaining unit sets the calculation formula in such a manner that the larger change amount is to be caused in the second contribution degree of a reference parameter when the setting value of the reference parameter is different, the larger weight is applied to the reference parameter with respect to the flexibility index. The evaluating device is configured to make the evaluation on the basis of the flexibility index calculated as a quantitative value that comprehensively takes into account the capabilities having impact on the operational flexibility. It is therefore possible to properly evaluate the operational flexibility in response to a demand for electric power.

It is preferable that the calculation formula obtaining unit sets, for each of the reference parameters, a coefficient by which a value based on the reference parameter value is to be multiplied, and the calculation formula obtaining unit sets the coefficients in such a manner that the larger change amount is to be caused in the second contribution degree of a reference parameter when the setting value of the reference parameter is different, the larger is a value of the coefficient of the reference parameter. By using the evaluating device, it is possible to more properly evaluate the capabilities having impact on the operational flexibility. It is therefore possible to properly evaluate the operational flexibility of the power generation facility.

It is preferable that the calculation formula obtaining unit sets, as the calculation formula, a formula that adds together, in correspondence with the operational capabilities, values each obtained by multiplying the value based on the reference parameter value by the coefficient. By using the evaluating device, it is possible to more properly evaluate the capabilities having impact on the operational flexibility. It is therefore possible to properly evaluate the operational flexibility of the power generation facility.

It is preferable that the contribution degree obtaining unit obtains information about the first contribution degree with respect to each of electric power markets, the power supply amount calculating unit calculates the power supply amount with respect to each of the electric power markets, and the contribution degree calculating unit calculates the second contribution degree on a basis of the power supply amount of each of the electric power markets. By using the evaluating device, it is possible to properly evaluate the operational flexibility of the power generation facility, even when the electric power is supplied to the plurality of power markets.

It is preferable that the contribution degree obtaining unit obtains a price of electric power that is set for each unit time period, as the first contribution degree, and the power supply amount calculating unit calculates, on a basis of the price of the electric power set for each unit time period, the power supply amount in each time period, so as to maximize an income that will be yielded when electric power is supplied by operating the predetermined power generation facility while using the reference parameter groups. The evaluating device is configured to evaluate the operational flexibility of the power generation facility from a viewpoint of incomes. It is therefore possible to properly evaluate the operational flexibility of the power generation facility.

It is preferable that the contribution degree calculating unit calculates, as the second contribution degree, a profit of the predetermined power generation facility to be yielded when electric power is supplied in the calculated power supply amount. By using the evaluating device, it is possible to properly evaluate the operational flexibility of the power generation facility from a viewpoint of profits.

It is preferable that the reference parameters include at least one of: a start-up time period of the power generation facility; a minimum operation duration indicating a minimum time period during which the power generation facility needs to continue operating; a minimum halt duration indicating a time period during which the power generation facility needs to remain at a halt; an output fluctuation rate of the power generation facility; and a lowest output ratio of the power generation facility to a rated output. The evaluating device is configured to use the abovementioned factors as the reference parameters. It is therefore possible to properly evaluate the operational flexibility of the power generation facility.

To solve the problems described above and achieve the object, a power generation facility evaluating system includes: the power generation facility evaluating device; and a detecting device that is provided for the power generation facility and detects the plurality of reference parameter values of the power generation facility, wherein the parameter value obtaining unit obtains the reference parameter values from the detecting device. The evaluating system is configured to calculate the flexibility index by using the actual parameters of the power generation facility detected by the detecting device. It is therefore possible to properly evaluate the operational flexibility of the power generation facility.

To solve the problems described above and achieve the object, a power generation facility evaluating method executed by a computer includes: obtaining a calculation formula used for calculating a flexibility index indicating operational flexibility in response to a demand for electric power, while using, as variables, a plurality of types of reference parameters which are parameters regarding flexibility capabilities of a power generation facility having impact on the operational flexibility in response to the demand for the electric power; obtaining a reference parameter value of each of the reference parameters with respect to a power generation facility subject to an evaluation; calculating the flexibility index of the power generation facility subject to the evaluation, by inputting the obtained reference parameter values to the calculation formula; and evaluating the operational flexibility of the power generation facility subject to the evaluation, on a basis of the calculated flexibility index, wherein the obtaining the calculation formula includes obtaining the calculation formula set in such a manner that weights applied with respect to the flexibility index are different in correspondence with the types of reference parameters. By using the evaluating method, it is possible to properly evaluate the operational flexibility in response to a demand for electric power.

To solve the problems described above and achieve the object, a computer program product has a non-transitory computer readable medium including programmed instructions, wherein the instructions, when executed by a computer, cause the computer to perform: obtaining a calculation formula used for calculating a flexibility index indicating operational flexibility in response to a demand for electric power, while using, as variables, a plurality of types of reference parameters which are parameters regarding flexibility capabilities of a power generation facility having impact on the operational flexibility in response to the demand for the electric power; obtaining a reference parameter value of each of the reference parameters with respect to a power generation facility subject to an evaluation; calculating the flexibility index of the power generation facility subject to the evaluation, by inputting the obtained reference parameter values to the calculation formula; and evaluating the operational flexibility of the power generation facility subject to the evaluation, on a basis of the calculated flexibility index, wherein the obtaining the calculation formula includes obtaining the calculation formula set in such a manner that weights applied with respect to the flexibility index are different in correspondence with the types of reference parameters. By using the computer program product, it is possible to properly evaluate the operational flexibility in response to a demand for electric power.

### Advantageous Effects of Invention

According to at least one aspect of the present disclosure, it is possible to properly evaluate the operational flexibility of the power generation facility in response to a demand for electric power.

### BRIEF DESCRIPTION OF DRAWINGS

FIG. 1 is a schematic block diagram of an evaluating device according to a first embodiment.

FIG. 2 is a block diagram of the evaluating device according to the first embodiment.

FIG. 3 is a drawing illustrating an example of a correspondence table of parameter indices.

FIG. 4 is a flowchart for explaining a flow in a flexibility evaluating process for a power generation facility according to the first embodiment.

FIG. 5 is a schematic block diagram of an evaluating system according to another example of the first embodiment.

FIG. 6 is a block diagram of an evaluating device according to a second embodiment.

FIG. 7 is a graph illustrating examples of electric power supply amounts per unit time period.

FIG. 8 is a graph illustrating examples of a first contribution degree.

FIG. 9 is a graph illustrating more examples of the first contribution degree.

FIG. 10 is a graph illustrating other examples of the first contribution degree.

FIG. 11 is a table illustrating examples of reference parameter groups.

FIG. 12 is a graph illustrating examples of calculation values of electric power supply amounts in each time period.

FIG. 13 is a graph illustrating examples of magnitudes of change amounts in a second contribution degree.

FIG. 14 is a flowchart for explaining a flow in a flexibility evaluating process for a power generation facility according to the second embodiment.

FIG. 15 is a graph illustrating an example of a method for setting a price of electric power.

### DESCRIPTION OF EMBODIMENTS

Exemplary embodiments of the present disclosure will be explained in detail below, with reference to the accompanying drawings. The present disclosure is not limited to the embodiments described below. Further, when two or more embodiments are presented, possible embodiments include combinations of any of the embodiments.

### First Embodiment

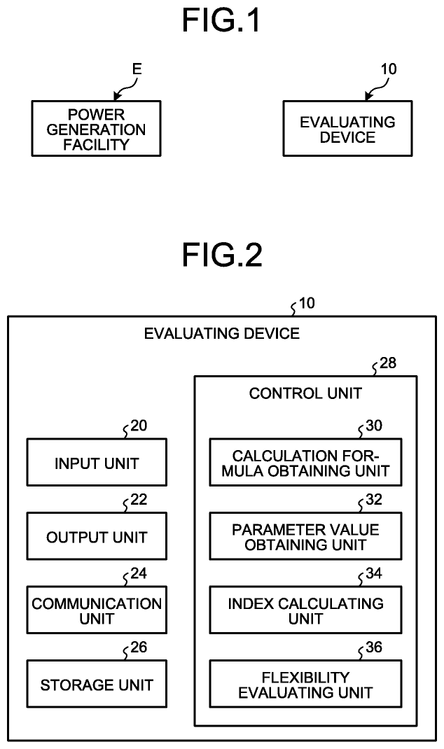

FIG. 1 is a schematic block diagram of an evaluating device according to a first embodiment. As illustrated in FIG. 1, an evaluating device 10 according to the first embodiment is configured to evaluate operational flexibility of a power generation facility E.

The power generation facility E according to the present embodiment is a thermal power generation facility and is, more specifically, a gas turbine. The power generation facility E is an arbitrary power generation facility and does not necessarily have to be a gas turbine. It is, however, desirable when the power generation facility E is not a power generation facility of which the output can fluctuate according to changes in the natural environment (e.g., a solar power generation facility, a wind power generation facility), but is a power generation facility of which the input amount is controllable. In this situation, the input amount denotes an input value used for generating electric power (an output; hereinafter, simply “power”) and may be, for example, the amount of fuel used in thermal power generation. For the power generation facility E, an output amount (i.e., a power supply amount) is determined in accordance with the input amount. The power generation facility E is connected to a system serving as a power supply system and is configured to supply the generated power to the system. The system is also connected to a load that consumes the power and may also be connected to another power generation facility. The power supplied from power generation facilities including the power generation facility E is supplied to the load via the system. In this situation, the number of power generation facilities connected to the system other than the power generation facility E is arbitrary. The types of the power generation facilities other than the power generation facility E are also arbitrary and may include, in the present embodiment, one or more power generation facilities of which the output can fluctuate according to changes in the natural environment (weather, etc.) such as a solar power generation facility, a wind power generation facility, and the like. It should be noted, however, that the power generation facility E subject to an evaluation by the evaluating device 10 does not necessarily have to be generating power while being connected to a system and may be generating no power due to being in a pre-operation state or at a halt, for example.

Operational flexibility of the power generation facility E denotes a degree to which the power generation facility is able to absorb rapid fluctuations in the demand for power, voltage, frequencies, and the like of the system. In other words, when having high operational flexibility, the power generation facility E is able to more properly absorb rapid fluctuations in power supply amounts, voltage, frequencies, and the like of the system. For example, power generation facilities are considered to have higher operational flexibility when being capable of increasing or decreasing the power supply amount in a shorter period of time or being capable of increasing or decreasing a power supply amount per unit time period by a large change amount. In the following sections, capabilities of the power generation facility E having impact on the operational flexibility will be referred to as “flexibility capabilities”. Specific examples of the flexibility capabilities will be explained later.

FIG. 2 is a block diagram of the evaluating device according to the first embodiment. The evaluating device 10 is a device configured to evaluate the operational flexibility of the power generation facility E. The evaluating device 10 is a computer in the present embodiment and may be included in the power generation facility E or may be included in another facility different from the power generation facility E. As illustrated in FIG. 2, the evaluating device 10 includes an input unit 20, an output unit 22, a communication unit 24, a storage unit 26, and a control unit 28. The input unit 20 is a device configured to receive inputs from a user and may be, for example, a mouse, a keyboard, a touch panel, or the like. The output unit 22 is a device configured to display results of control exercised by the control unit 28, what is input by the user, and the like. In the present embodiment, the output unit 22 may be a display device or a touch panel. The communication unit 24 is a mechanism configured to communicate with external devices and is a communication interface, in other words. The communication unit 24 may be, for example, a Wi-Fi (registered trademark) module, an antenna, or the like. The storage unit 26 is a memory configured to store therein what is calculated by the control unit 28, information about computer programs, and the like. The storage unit 26 includes at least one selected from among: a Random Access Memory (RAM), a Read-Only Memory (ROM), and an external storage device such as a Hard Disk Drive (HDD).

The control unit 28 is a computation device, i.e., a Central Processing Unit (CPU). The control unit 28 includes: a calculation formula obtaining unit 30, a parameter value obtaining unit 32, an index calculating unit 34, and a flexibility evaluating unit 36. The calculation formula obtaining unit 30, the parameter value obtaining unit 32, the index calculating unit 34, and the flexibility evaluating unit 36 are realized and configured to perform processes described below, as a result of the control unit 28 reading software (one or more computer program) stored in the storage unit 26.

The calculation formula obtaining unit 30 illustrated in FIG. 2 is configured to obtain a calculation formula that is used for calculating a flexibility index FI and that employs reference parameters as variables. The reference parameters are parameters regarding the flexibility capabilities, which are capabilities of the power generation facility having impact on the operational flexibility. It is considered that the reference parameters indicate different types of the flexibility capabilities. Further, values of the reference parameters, i.e., reference parameter values, are each a value of the corresponding reference parameter, i.e., a value of the corresponding flexibility capability. For example, when one of the reference parameters is a start-up time period of the power generation facility, the value of the reference parameter is a value (e.g., 30 minutes) indicating the start-up time period of the power generation facility. The flexibility index FI is an index indicating a degree of operational flexibility of the power generation facility E. For example, the larger the flexibility index FI is, the higher evaluation can be made of the operational flexibility of the power generation facility E in response to a demand for power.

The reference parameters in the present embodiment may include: the start-up time period of the power generation facility, the minimum operation duration of the power generation facility, the minimum halt duration of the power generation facility, an output fluctuation rate of the power generation facility, and the lowest output ratio of the power generation facility. The start-up time period is a time period it takes for the power generation facility to transition from a halt state into a state in which an output is yieldable (hereinafter, “output yieldable state”). The minimum operation duration is a time period during which the power generation facility needs to continue operating before the next halt. In other words, the minimum operation duration is a minimum time period during which the power generation facility needs to remain in the output yieldable state after having transitioned into the output yieldable state. The minimum halt duration is a time period during which the power generation facility needs to remain at a halt before the next start-up. In other words, the minimum halt duration is a minimum time period during which the power generation facility needs to remain in the halt state after having transitioned into the halt state. The output fluctuation rate denotes a possible fluctuation amount in the output of the power generation facility in a unit time period. In other words, the output fluctuation rate indicates how much it is possible to fluctuate the output (the power supply amount) in the unit time period. The lowest output ratio denotes a ratio of the lowest output (the smallest value of power supply amounts) to a rated output (a power supply amount at a rated level) of the power generation facility. Preferably, the reference parameters include at least one selected from a group consisting of at least the start-up time period of the power generation facility, the minimum operation duration of the power generation facility, the minimum halt duration of the power generation facility, the output fluctuation rate of the power generation facility, and the lowest output ratio of the power generation facility, and more preferably, include two or more selected from among the same group. It should be noted, however, that the reference parameters may indicate any other factors besides those described above, as long as the reference parameters indicate such capabilities that have impact on the operational flexibility.

As explained above, the reference parameters used in the calculation formula of the flexibility index FI represent such capabilities of the power generation facility that have impact on the operational flexibility. In other words, the references parameters are extracted as parameters having impact on the operational flexibility, from among various types of parameters (capabilities) of the power generation facility. Further, it is desirable when the reference parameters are parameters relevant to a fluctuation speed of the supplied power from the power generation facility. In the present embodiment, the reference parameters used in the calculation formula of the flexibility index FI are set in advance. In other words, the calculation formula obtaining unit 30 obtains the calculation formula of the flexibility index FI that employs the reference parameters set in advance as the variables thereof.

More specifically, the calculation formula obtaining unit 30 obtains the calculation formula of the flexibility index FI that employs, as the variables, a plurality of types of reference parameters of the power generation facility E. In the present embodiment, as the calculation formula of the flexibility index FI, the calculation formula obtaining unit 30 obtains the calculation formula presented as Expression (1) below.

FI=K1·PA+K2·PB+K3·PC+K4·PD+K5·PE (1)

In Expression (1), PA, PB, PC, PD, and PE are variables calculated on the basis of reference parameter values and will hereinafter be referred to as parameter indices. Each of the parameter indices is a value calculated for a different one of the reference parameters. In an example of the present embodiment, PA is a parameter index of the start-up time period of the power generation facility; PB is a parameter index of the minimum operation duration of the power generation facility; PC is a parameter index of the minimum operation duration of the power generation facility; PD is a parameter index of the minimum halt duration of the power generation facility; and PE is a parameter index the lowest output ratio of the power generation facility. Because the parameter indices are calculated by the index calculating unit 34 explained later, a calculation method will be explained later. The number of parameter indices corresponds to the number of reference parameters and does not necessarily have to be five as indicated in Expression (1).

The symbols K1, K2, K3, K4, and K5 denote coefficients with which the parameter indices are multiplied and are constants set in advance. Each of the coefficients is set for a different one of the parameter indices, i.e., for a different one of the reference parameters. In an example of the present embodiment, the coefficient K1 is a coefficient corresponding to PA serving as the parameter index of the start-up time period of the power generation facility; the coefficient K2 is a coefficient corresponding to PB serving as the parameter index of the minimum operation duration of the power generation facility; the coefficient K3 is a coefficient corresponding to PC serving as the parameter index of the minimum operation duration of the power generation facility; the coefficient K4 is a coefficient corresponding to the parameter index of the minimum halt duration of the power generation facility; and the coefficient K5 is a coefficient corresponding to the parameter index of the lowest output ratio of the power generation facility. In the following sections, the coefficients K1, K2, K3, K4, and K5 may be referred to as coefficients K, when not being distinguished from one another.

As explained above, the flexibility index FI is calculated as a value adding together the values (products) each obtained by multiplying a parameter index based on a reference parameter value by a coefficient K, in correspondence with the different types of reference parameters (parameter indices), where the values of the coefficients K are different in correspondence with the different types of reference parameters. Further, in the calculation formula of the flexibility index FI, it is preferable to determine the values of the coefficients K in such a manner that the higher relevance a reference parameter has to the fluctuation speed of the supplied power, the larger is the value of the coefficient K corresponding to the reference parameter. In addition, it is more preferable to determine the values of the coefficients K corresponding to the plurality of types of reference parameters in such a manner that the value of the coefficient K corresponding to the reference parameter having the highest relevance to the fluctuation speed of the supplied power is the largest. To summarize the above, the flexibility index FI is calculated by adding together the reference parameter values (the parameter indices) each weighted with respect to the flexibility index FI, in correspondence with the reference parameters (the parameter indices). The weights applied with respect to the flexibility index FI are different in correspondence with the different types of reference parameters. Further, the calculation formula of the flexibility index FI is structured in such a manner that the higher relevance a reference parameter has to the fluctuation speed of the supplied power, the larger weight is applied with respect to the flexibility index FI. It is therefore considered that the largest weight is applied with respect to the flexibility index FI, for the reference parameter having the highest relevance to the fluctuation speed of the supplied power. The reference parameter having the highest relevance to the fluctuation speed of the supplied power may be, for example, the output fluctuation rate, but does not necessarily have to be the output fluctuation rate.

The parameter value obtaining unit 32 is configured to obtain the reference parameter values of the power generation facility E subject to the evaluation. In other words, the parameter value obtaining unit 32 obtains values (reference parameter values) of the parameters that are the same as the reference parameters in the calculation formula of the flexibility index FI of the power generation facility E. The parameter value obtaining unit 32 may obtain the reference parameter values of the power generation facility E by using an arbitrary method. For example, the reference parameter values of the power generation facility E may be set in advance as design values, so that the parameter value obtaining unit 32 according to the present embodiment obtains the values that are set in advance, as the reference parameter values of the power generation facility E. The parameter value obtaining unit 32 may obtain the reference parameter values from an external server via the communication unit 24 or may read the reference parameter values stored in the storage unit 26 in advance.

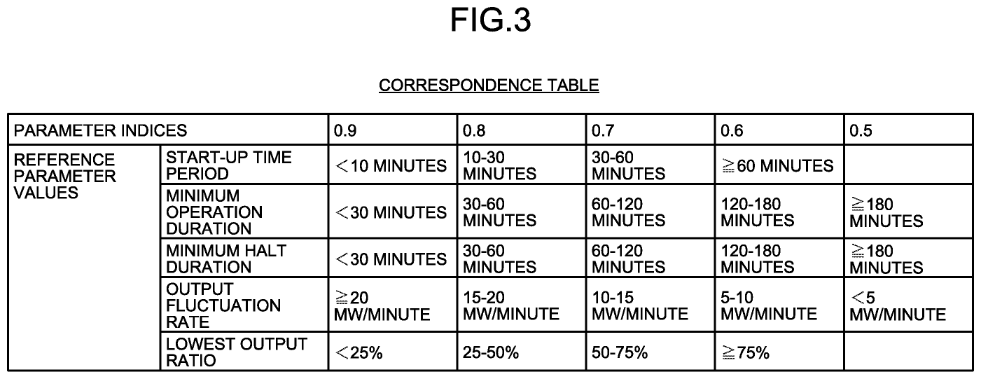

The index calculating unit 34 illustrated in FIG. 2 is configured to calculate the flexibility index FI of the power generation facility E, by inputting the reference parameter values of the power generation facility E obtained by the parameter value obtaining unit 32 to the calculation formula obtained by the calculation formula obtaining unit 30. More specifically, the index calculating unit 34 converts the reference parameter values of the power generation facility E into the parameter indices and further inputs the values of the parameter indices resulting from the conversion to the calculation formula obtained by the calculation formula obtaining unit 30. FIG. 3 is a drawing illustrating an example of a correspondence table of the parameter indices. In the present embodiment, the storage unit 26 has stored therein the correspondence table illustrated in FIG. 3 in which reference parameter values and parameter indices are kept in correspondence with each other. As illustrated in FIG. 3, the correspondence table keeps the reference parameter values and the parameter indices in correspondence with each other, by dividing a possible numerical value range of reference parameter values, into a plurality of numerical value range sections and further assigning parameter indices having mutually-different values to the numerical value range sections, respectively. The correspondence table keeps the reference parameter values and the parameter indices in correspondence with each other, with respect to the respective reference parameters.

In the example in FIG. 3, for the start-up time period, the reference parameter values of the power generation facility E are divided into the ranges of “shorter than 10 minutes”, “10 minutes or longer but shorter than 30 minutes”, “30 minutes or longer but shorter than 60 minutes”, and “60 minutes or longer”, so as to assign parameter indices 0.9, 0.8, 0.7, and 0.6 to the ranges, respectively. In other words, the longer the start-up time period is, the smaller is the parameter index. Further, in the example in FIG. 3, for the minimum operation duration and the minimum halt duration, the reference parameter values of the power generation facility E are divided into the ranges of “shorter than 30 minutes”, “30 minutes or longer but shorter than 60 minutes”, “60 minutes or longer but shorter than 120 minutes”, “120 minutes or longer but shorter than 180 minutes”, and “180 minutes or longer”, so as to assign parameter indices 0.9, 0.8, 0.7, 0.6, and 0.5 to the ranges, respectively. In other words, the longer the minimum operation duration or the minimum halt duration is, the smaller is the parameter index. Further, in the example in FIG. 3, for the output fluctuation rate, the reference parameter values of the power generation facility E are divided into the ranges of “20 MW/minute or larger”, “15 MW/minute or larger but smaller than 20 MW/minute”, “10 MW/minute or larger but smaller than 15 MW/minute”, “5 MW/minute or larger but smaller than 10 MW/minute”, and “smaller than 5 MW/minute”, so as to assign parameter indices 0.9, 0.8, 0.7. 0.6, and 0.5 to the ranges, respectively. In other words, the smaller the output fluctuation rate is, the smaller is the parameter index. Further, in the example in FIG. 3, for the lowest output ratio, the reference parameter values of the power generation facility E are divided into the ranges of “lower than 25%”, “25% or higher but lower than 59%”, “50% or higher but lower than 75%”, and “75% or higher”, so as to assign parameter indices 0.9, 0.8, 0.7, and 0.6 to the ranges, respectively. In other words, the higher the lowest output ratio is, the smaller is the parameter index. It should be noted that the correspondence relationship between the reference parameter values and the parameter indices illustrated in FIG. 3 are merely examples.

As explained above, the index calculating unit 34 calculates the flexibility index FI of the power generation facility E, by extracting the respective parameter indices of the reference parameters from the reference parameter values and further inputting the extracted parameter indices to the calculation formula obtained by the calculation formula obtaining unit 30.

As explained above, because the flexibility index FI is a value calculated on the basis of the reference parameter values of the power generation facility E, the flexibility index FI is considered to be a value quantitatively indicating how much operational flexibility the power generation facility E has. Further, because the flexibility index FI is calculated on the basis of the plurality of reference parameter values, even when there are two or more capabilities (reference parameters) having impact on the operational flexibility, the flexibility index FI serves as a value that comprehensively takes into account those capabilities having impact on the operational flexibility. Furthermore, the flexibility index FI is calculated by using the calculation formula obtained by the calculation formula obtaining unit 30, while the calculation formula is set in such a manner that the weights applied with respect to the flexibility index FI are different in correspondence with the reference parameters. Accordingly, even when there are two or more capabilities having impact on the operational flexibility, the flexibility index FI serves as a value that properly takes into account those capabilities having impact on the operational flexibility.

The flexibility evaluating unit 36 illustrated in FIG. 2 is configured to evaluate the operational flexibility of the power generation facility E, on the basis of the flexibility index FI calculated by the index calculating unit 34. Because the flexibility index FI is a value quantitatively indicating the operational flexibility of the power generation facility E, the flexibility evaluating unit 36 is able to properly evaluate the operational flexibility of the power generation facility E, by using the flexibility index FI. For example, the calculation formula is applicable not only to the power generation facility E, but also to other power generation facilities joining the same power market. Accordingly, as a result of the index calculating unit 34 calculating flexibility indices FI of a plurality of power generation facilities including the power generation facility E by using the same calculation formula so that the flexibility evaluating unit 36 further compares the flexibility indices FI with one another, it is possible to evaluate how much operational flexibility the power generation facility E has, in comparison to the other power generation facilities. Further, for example, by setting a reference value for the flexibility index FI in advance and comparing the reference value with the flexibility index FI of the power generation facility E, it is possible to evaluate whether or not the power generation facility E satisfies the reference level of the operational flexibility. Further, by continuously calculating values of the flexibility index FI with respect to the same power generation facility E and comparing the values of the flexibility index FI with one another, it is also possible to assess a degree of deterioration of the power generation facility E from a viewpoint of operational flexibility. Accordingly, for example, it is possible to properly set times to replace component parts of the power generation facility E or the like, from the viewpoint of the operational flexibility. Further, on the basis of the flexibility index FI, it is also possible to propose more effective operational conditions for improving the operational flexibility. Further, by calculating an average value of the flexibility indices FI of all the power generation facilities that are present in a certain market, it is possible to evaluate whether or not the operational flexibility of the market is sufficiently fulfilled. For example, when a new power generation facility is to be introduced to the market, it is possible to adopt a power generation facility having a larger flexibility index FI than the market average value of the flexibility indices FI. In this manner, it is possible to use the flexibility index FI to judge whether or not a new power generation facility should be adopted so that it is possible to raise the market average value of the flexibility indices FI. Further, by calculating a market average value of the flexibility indices FI every year, it is possible to track the transitions. In addition, by comparing the market average value with market average values of other markets, it is possible to understand the standing position of the market. Similarly, when a power generation business owner owning a plurality of power generation facilities calculates an average value of flexibility indices FI of the power generation facilities owned thereby, it is possible to make a comparison evaluation of the operational flexibility among power generation business owners. Accordingly, it is possible to use the flexibility indices FI for the purpose of prompting power generation business owners exhibiting small flexibility indices FI to make improvements.

The flexibility evaluating unit 36 may evaluate the operational flexibility of the power generation facility E by displaying the value of the flexibility index FI on the output unit 22 and providing a notification about the value of the flexibility index FI. Alternatively, the flexibility evaluating unit 36 may evaluate the operational flexibility of the power generation facility E, by deriving the abovementioned evaluation result (how much operational flexibility the power generation facility E has, how much the power generation facility E has deteriorated, or the like) based on the flexibility index FI. The evaluation result may be displayed on the output unit 22. Further, on the basis of the evaluation result obtained by the flexibility evaluating unit 36, the power generation facility E may set an operation pattern thereof. For example, by referring to the evaluation result obtained by the flexibility evaluating unit 36, a control device controlling the operation of the power generation facility E may set the operation pattern of the power generation facility E so as to increase the value of the flexibility index FI. Further, the controlling device controlling the operation of the power generation facility E may determine whether or not any of the component parts of the power generation facility E should be replaced, on the basis of the evaluation result obtained by the flexibility evaluating unit 36, i.e., the degree of deterioration of the components parts of the power generation facility E from the viewpoint of the operational flexibility, and may provide a notification indicating the determined result.

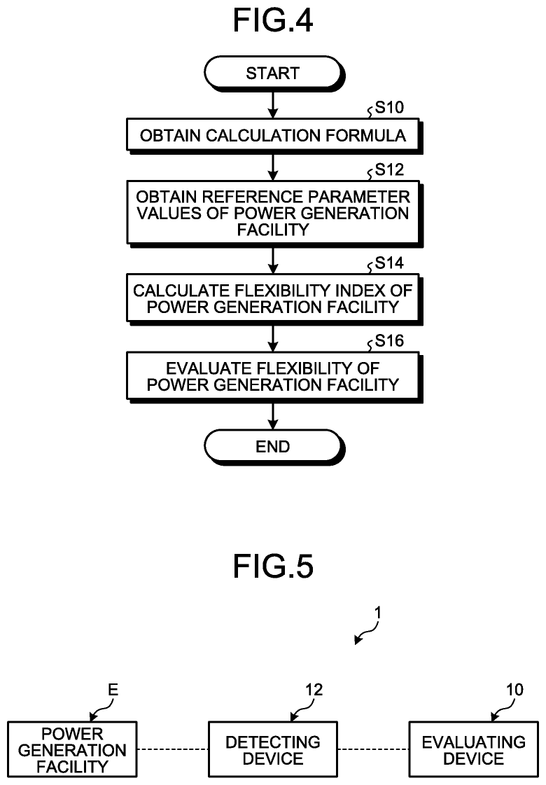

Next, a flow in the operational flexibility evaluating process for the power generation facility E described above will be explained with reference to a flowchart. FIG. 4 is the flowchart for explaining the flow in the flexibility evaluating process for the power generation facility according to the first embodiment. As illustrated in FIG. 4, by employing the calculation formula obtaining unit 30, the evaluating device 10 obtains the calculation formula of the flexibility index FI (step S10). After that, by employing the parameter value obtaining unit 32, the evaluating device 10 obtains the reference parameter values of the power generation facility E (step S12) and calculates the flexibility index FI of the power generation facility E by inputting the reference parameter values of the power generation facility E to the calculation formula (step S14). Further, by employing the flexibility evaluating unit 36, the evaluating device 10 evaluates operational flexibility of the power generation facility E, by using the flexibility index FI (step S16).

As explained above, the evaluating device 10 for the power generation facility E according to the present embodiment includes: the calculation formula obtaining unit 30, the parameter value obtaining unit 32, the index calculating unit 34, and the flexibility evaluating unit 36. The calculation formula obtaining unit 30 is configured to obtain the calculation formula used for calculating the flexibility index FI indicating the operational flexibility in response to a demand for power, while using the plurality of types of reference parameters as the variables. In the calculation formula, the weights applied with respect to the flexibility index FI are different in correspondence with the different types of reference parameters. Further, the reference parameters are parameters regarding the flexibility capabilities of the power generation facility having impact on the operational flexibility in response to a demand for power. The parameter value obtaining unit 32 is configured to obtain the reference parameter value of each of the reference parameters, with respect to the power generation facility E subject to the evaluation. The index calculating unit 34 is configured to calculate the flexibility index FI of the power generation facility E subject to the evaluation, by inputting the reference parameter values obtained by the parameter value obtaining unit 32 to the calculation formula. The flexibility evaluating unit 36 is configured to evaluate the power generation facility E subject to the evaluation, on the basis of the calculated flexibility index FI.

In this regard, because the operational flexibility of the power generation facility E changes according to various capabilities of the power generation facility E, it is difficult to accurately evaluate how much operational flexibility the power generation facility E has. To cope with this situation, the evaluating device 10 according to the present embodiment calculates the flexibility index FI by using the calculation formula reflecting the plurality of reference parameters that are relevant to the operational flexibility of the power generation facility E. Further, the evaluating device 10 is configured to calculate the flexibility index FI by using the calculation formula in which the weights applied with respect to the flexibility index FI are different in correspondence with the reference parameters. Accordingly, the flexibility index FI is a quantitative value that comprehensively takes into account the capabilities having impact on the operational flexibility. By evaluating the operational flexibility of the power generation facility E while using the flexibility index FI calculated in this manner, the evaluating device 10 is able to properly evaluate the operational flexibility in response to a demand for power.

Further, the calculation formula obtained by the calculation formula obtaining unit 30 uses the parameters relevant to the fluctuation speed of the supplied power of the power generation facility as the plurality of types of reference parameters. Further, the calculation formula is structured in such a manner that, among the plurality of types of reference parameters, the largest weight is applied to the parameter having the highest relevance to the fluctuation speed of the supplied power. The evaluating device 10 is configured to apply larger weights to reference parameters having higher relevance to the fluctuation speed of the supplied power. It is therefore possible to calculate the flexibility index FI properly reflecting the operational flexibility and to properly evaluate the operational flexibility in response to a demand for power.

Further, the flexibility capability is at least one selected from among: the start-up time period of the power generation facility; the minimum operation duration indicating a minimum time period during which the power generation facility needs to continue operating; the minimum halt duration indicating a time period during which the power generation facility needs to remain at a halt; the output fluctuation rate of the power generation facility; and the lowest output ratio of the power generation facility to the rated output. Because the evaluating device 10 is configured to use these factors as the flexibility capabilities, the evaluating device 10 is able to properly evaluate the operational flexibility of the power generation facility E.

In the first embodiment, the parameter value obtaining unit 32 is configured to obtain the reference parameter values that are set in advance; however, the parameter value obtaining unit 32 may obtain measurement values of the reference parameters of the power generation facility E as reference parameter values. FIG. 5 is a schematic block diagram of an evaluating system according to another example of the first embodiment. As illustrated in FIG. 5, an evaluating system 1 according to said another example of the first embodiment includes the evaluating device 10 and a detecting device 12. The evaluating system 1 may structure a power generation system, together with the power generation facility E. The detecting device 12 is a sensor connected to the power generation facility E and configured to detect the reference parameter values of the power generation facility E.

In the present example, the parameter value obtaining unit 32 is configured to obtain the reference parameter values of the power generation facility E detected by the detecting device 12, from the detecting device 12 via the communication unit 24. In the present example, the detecting device 12 detects the start-up time period of the power generation facility E, by measuring the time period it takes for the power generation facility E to transition from a halt state to an output yieldable state. Further, the detecting device 12 detects the minimum operation duration of the power generation facility E, by measuring a minimum time period during which, after transitioning into an output yieldable state, the power generation facility E needs to remain in the output yieldable state. The detecting device 12 also detects the minimum halt duration of the power generation facility E by measuring a minimum time period during which, after transitioning into a halt state, the power generation facility E needs to remain in the halt state. Further, the detecting device 12 detects the output fluctuation rate of the power generation facility E, by measuring a possible fluctuation amount in the output of the power generation facility E per unit time period. Also, the detecting device 12 detects the lowest output ratio of the power generation facility E by measuring the rated output and the lowest output of the power generation facility. The parameter value obtaining unit 32 obtains these detection values detected by the detecting device 12 as the reference parameter values of the power generation facility E.

By using the reference parameter values obtained by the parameter value obtaining unit 32 in this manner, the index calculating unit 34 calculates a flexibility index FI. As explained above, the evaluating system 1 includes the evaluating device 10 and the detecting device 12. The detecting device 12 is provided for the power generation facility E and is configured to detect the plurality of reference parameter values of the power generation facility E. The parameter value obtaining unit 32 is configured to obtain the reference parameter values from the detecting device 12. The evaluating system 1 is configured to calculated the flexibility index FI by using the actual parameters of the power generation facility E detected by the detecting device 12. It is therefore possible to properly evaluate the operational flexibility of the power generation facility E. Also, in a second embodiment described below, the parameter value obtaining unit 32 may obtain reference parameter values that are set in advance or may obtain reference parameter values detected by the detecting device 12.

### Second Embodiment

Next, the second embodiment will be explained. An evaluating device 10A according to the second embodiment is different from that in the first embodiment with regard to setting a calculation formula of the flexibility index FI. In the second embodiment, explanations of some of the configurations that are the same as those in the first embodiment will be omitted.

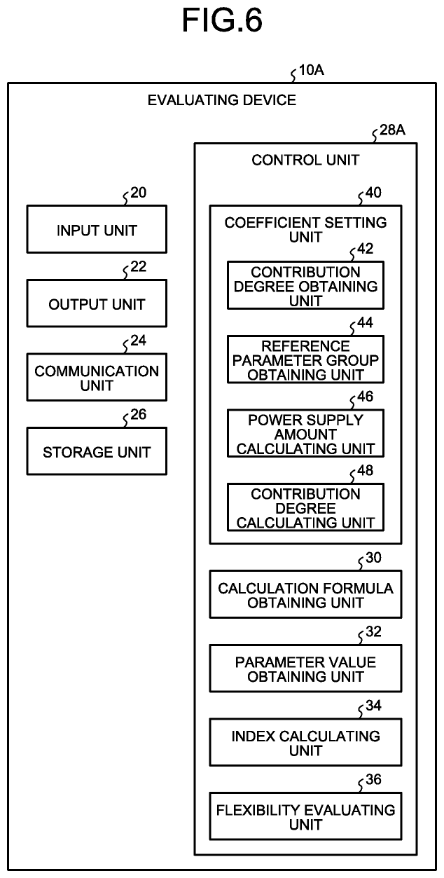

FIG. 6 is a block diagram of an evaluating device according to the second embodiment. In the evaluating device 10A according to the second embodiment, a control unit 28A includes a coefficient setting unit 40, in addition to the calculation formula obtaining unit 30, the parameter value obtaining unit 32, the index calculating unit 34, and the flexibility evaluating unit 36. The coefficient setting unit 40 is configured to perform an analysis to enable the calculation formula obtaining unit 30 to set the calculation formula of the flexibility index FI. In other words, the coefficient setting unit 40 performs the analysis to determine magnitudes of the weights to be applied to the reference parameters in the calculation formula of the flexibility index FI. The coefficient setting unit 40 includes a contribution degree obtaining unit 42, a reference parameter group obtaining unit 44, a power supply amount calculating unit 46, and a contribution degree calculating unit 48.

The contribution degree obtaining unit 42 is configured to obtain a first contribution degree. The first contribution degree is an index indicating a degree of contribution to stabilization of a system S and is assigned to a power supply amount per unit time period. The stabilization of the system S denotes stabilizing the power supply to the system S, by inhibiting deviation of supply/demand balance of power, as well as fluctuations of voltage and frequencies and the like in the system S. Because the first contribution degree is a value assigned to the power supply amount per unit time period, the value changes in each unit time period.

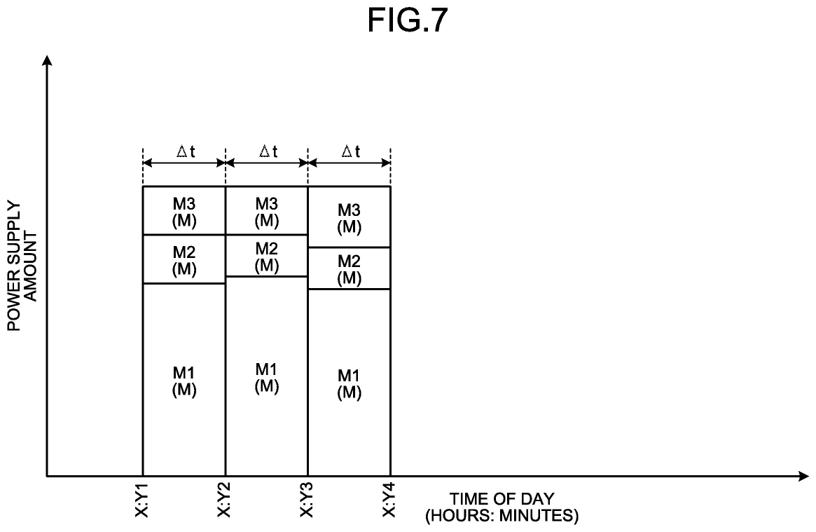

Before specifically explaining the first contribution degree, the power supply amount per unit time period will be explained. FIG. 7 is a graph illustrating examples of power supply amounts per unit time period. As illustrated in FIG. 7, a power facility is configured to supply power in each unit time period and, more specifically, may be configured, in some situations, to supply power while distributing a supplied power amount among a plurality of power markets M in each unit time period. For example, FIG. 7 illustrates the examples of the power supply amounts by a prescribed power facility at each of different points in time within a length of time that is set in advance, i.e., in each of the unit time periods Δt having a predetermined length, such as “from time X:Y1 to time X:Y2”, “from time X:Y2 to time X:Y3”, “from time X:Y3 to time X:Y4”, and so on where X denotes hours and Y1, Y2, Y3, and Y4 each denote minutes of the time of day. Further, the power generation facility supplies power to a power market M1, a power market M2, and a power market M3 in each of the unit time periods Δt. As illustrated in the example in FIG. 7, the power supply amount of the power facility is normally different for each of the unit time periods Δt and is also different for each of the power markets M. The term “power markets M” denotes markets in which power is traded and is used for determining the power or the power amount to be supplied by the power generation facility at each of different points in time. In the power markets M, the price of the power amount or the power to be supplied per unit time period is determined with respect to each of the different points in time, and the determined price is different for each of the power markets M.

Examples of the power markets M include energy markets and ancillary service markets. An energy market is a market for determining a power supply amount per unit time period (Wh: Watt hours) with respect to each of different points in time. In an energy market, the price of a power amount per unit time period (Wh: Watt hours) is set with respect to each of the different points in time. In an energy market, the price of the power amount per unit time period at a given point in time is determined prior to the given point in time. Further, examples of energy markets include day-ahead markets, intraday markets, and real-time markets, among which the timing of determining the price varies. At each of the different points in time, a power generation facility supplies the power amount determined in the energy market with respect to each of the different points in time. In contrast, ancillary service markets are markets for maintaining the power frequency of a system at a constant value in a unit time period and are markets for determining power (W: Watts) that can be supplied in the unit time period (i.e., power generation capacity) with respect to each of different points in time, which means that the markets are for determining so-called ΔkW values. Power generation facilities stay in the state of being able to supply the power determined in an ancillary service market so as to supply power in response to a request from a system operator. In other words, the value of the power determined in an ancillary service market is a maximum value of the power to be supplied by the power generation facility. The value of the power to be actually supplied is determined in accordance with the request from the system operator. Examples of ancillary service markets include frequency regulation power markets and emergency power markets. In a frequency regulation power market, a power generation facility continuously supplies power so as to keep a system power frequency constant, on the basis of successive instructions from a system operator. In an emergency power market, a power generation facility does not supply power during normal time when there are no instructions from a system operator and supplies requested power when being instructed from the system operator.

In FIG. 7, for example, the power market M1 is an energy market, while the power market M2 is a frequency regulation power market, and the power market M3 is an emergency power market. In other words, in the example in FIG. 7, the supplied power amount to each of the power markets M changes at each of the different points in time. Further, although the total value of power supply amounts is equal among the different points in time in the example in FIG. 7, the total value may vary among the different points in time. Further, the quantity of the power markets M is arbitrary and does not have to be three. Further, the power may be supplied according to a single power market M.

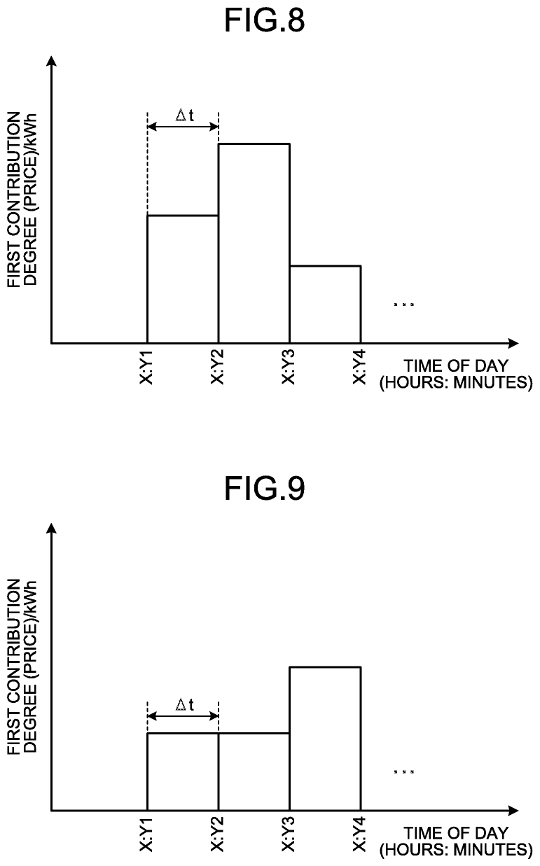

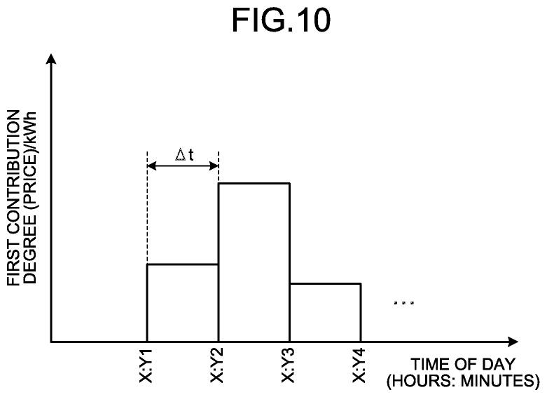

FIGS. 8 to 10 are graphs illustrating examples of the first contribution degree. The first contribution degree according to the present embodiment is a price of the power per unit time period with respect to the power markets M and, more specifically, the price of the power amount (Wh) or the power (W) per unit time period during a predetermined length of time (e.g., one year). The first contribution degree, i.e., the price of the power, is set with respect to each of the power markets M. For example, FIG. 8 illustrates examples of the first contribution degree in the power market M1, which is an energy market. FIG. 9 illustrates examples of the first contribution degree in the power market M2, which is a frequency regulation power market. FIG. 10 illustrates examples of the first contribution degree of the power market M3, which is an emergency market. As illustrated in FIGS. 8 to 10, the value of first contribution degree fluctuates at each of the different points in time, i.e., for each of the unit time periods Δt.

When the first contribution degree is set with respect to each of the power markets M as described above, it is desirable to configure the contribution degree obtaining unit 42 to obtain the first contribution degree with respect to each of the power markets M. In other words, when a plurality of types of first contribution degrees are set, it is desirable to configure the contribution degree obtaining unit 42 to obtain the plurality of types of first contribution degrees. Further, the contribution degree obtaining unit 42 is configured to obtain the first contribution degree in a predetermined length of time from the past, i.e., the price of the power per unit time period that is set in the past. For example, the contribution degree obtaining unit 42 obtains, as the first contribution degree, the price of the power per unit time period that is set in the power market in the length of time from a year ago to yesterday. The contribution degree obtaining unit 42 may obtain the first contribution degree from the past, from an external server via the communication unit 24 or may obtain the first contribution degree from the past stored in the storage unit 26 in advance.

As explained above, the contribution degree obtaining unit 42 obtains the price of the power per unit time period, as the first contribution degree. In power markets, there is a tendency that the higher the degree of contribution to stabilization of the system S is, the higher the price of the power is set to be. Accordingly, the first contribution degree is the price of the power, in other words. It should be noted, however, the first contribution degree does not necessarily have to be the price of the power, as long as a degree of contribution to stabilization of the system is indicated thereby. For example, the first contribution degree may be a system frequency per unit time period or a system voltage level per unit time period.

The reference parameter group obtaining unit 44 illustrated in FIG. 6 is configured to obtain reference parameter groups. The reference parameter groups are data groups containing a plurality of types of setting values of the reference parameters. In other words, the values of the reference parameters contained in each of the reference parameter groups are not the reference parameter values obtained by the parameter value obtaining unit 32, but are values set in advance. More specifically, the reference parameter groups are data groups containing, with respect to each of all the reference parameters, one reference parameter value that is set with respect to the one reference parameter. The plurality of reference parameter groups have mutually-different reference parameter values. In other words, the reference parameter values that are set with respect to mutually the same reference parameter vary among the reference parameter groups. The reference parameter group obtaining unit 44 may obtain the reference parameter groups from an external server via the communication unit 24 or may obtain the reference parameter groups stored in the storage unit 26 in advance. In the following sections, the setting values of the reference parameters contained in the reference parameter groups will be referred to as “reference parameter setting values”.

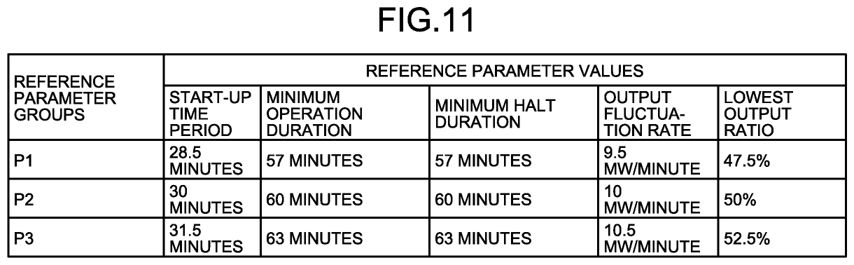

FIG. 11 is a table illustrating examples of the reference parameter groups. The examples in FIG. 11 illustrate reference parameter groups P1, P2, and P3. Among the reference parameter groups P1, P2, and P3, at least one of the reference parameter setting values is different. In other words, although all the reference parameter setting values are different among the reference parameter groups P1, P2, and P3 in the example in FIG. 11, it is acceptable when one of the reference parameter setting values (e.g., the start-up time periods in the first column) are mutually different. In the example in FIG. 11, in the reference parameter group P1, the reference parameter setting value of the start-up time period is 28.5 minutes; the reference parameter setting value of the minimum operation duration is 57 minutes; the reference parameter setting value of the minimum halt duration is 57 minutes; the reference parameter setting value of the output fluctuation rate is 9.5 MW/minute (Megawatts per minute); and the reference parameter setting value of the lowest output ratio is 47.5%. In the reference parameter group P2, the reference parameter setting value of the start-up time period is 30 minutes; the reference parameter setting value of the minimum operation duration is 60 minutes; the reference parameter setting value of the minimum halt duration is 60 minutes; the reference parameter setting value of the output fluctuation rate is 10 MW/minute (Megawatts per minute); and the reference parameter setting value of the lowest output ratio is 50%. Further, in the reference parameter group P3, the reference parameter setting value of the start-up time period is 31.5 minutes; the reference parameter setting value of the minimum operation duration is 63 minutes; the reference parameter setting value of the minimum halt duration is 63 minutes; the reference parameter setting value of the output fluctuation rate is 10.5 MW/minute (Megawatts per minute); and the reference parameter setting value of the lowest output ratio is 52.5%. In this manner, the reference parameter setting values in the reference parameter group P1 are minimum values when the reference parameter setting values in the reference parameter group P2 are used as central values and are smaller than the central values by a predetermined percentage (5% in the present example). Further, the reference parameter setting values in the reference parameter group P3 are maximum values when the reference parameter setting values in the reference parameter group P2 are used as central values and are larger than the central values by a predetermined percentage (5% in the present example). It should be noted that the reference parameter setting values and the quantity of the reference parameter groups may arbitrarily be set.

In this situation, if reference parameter groups were exhaustively set with respect to each of the reference parameters, i.e., if the plurality of reference parameter groups were set while varying only reference parameter setting values of one reference parameter, the number of reference parameter groups would be larger. For example, when three reference parameter setting values are set with each reference parameter, and there are five reference parameters, the number of possible combinations of the reference parameter is 3⁵. In this situation, because at least one reference parameter setting value is different among the reference parameter groups, it means, in other words, that the number of possible combinations of the reference parameters denotes the number of reference parameter groups. In contrast, in the present embodiment, the reference parameter setting values of all the reference parameters are different among the reference parameter groups. It is therefore possible to make the number of combinations of the reference parameters (the number of reference parameter groups) smaller than the situation where the reference parameters are combined in all possible combinations (3⁵ in the present example). In the example in FIG. 11, the number of combinations of the reference parameters (the number of reference parameter groups) is equal to the number of reference parameter setting values set with each of the reference parameters (three in the example in FIG. 11); however, this is merely an example. In the present embodiment, it is possible to keep small the number of combinations of the reference parameters (the number of reference parameter groups), by setting the reference parameter groups from a viewpoint of an experimental design method. It should be noted, however, that the number of combinations of the reference parameters (the number of reference parameter groups) is arbitrary. It is acceptable when reference parameters of at least a part of the flexibility capabilities are different among the reference parameter groups.

The power supply amount calculating unit 46 illustrated in FIG. 6 is configured to perform an analysis on the basis of the reference parameter groups and the first contribution degree values and to calculate a power supply amount of a predetermined power generation facility in each time period. More specifically, the power supply amount calculating unit 46 selects a power generation facility serving as a reference and obtains parameter values regarding capabilities of the selected power generation facility. The power supply amount calculating unit 46 is configured to select a power generation facility other than the power generation facility E subject to the evaluation, as the power generation facility serving as a reference. The selected power generation facility is arbitrary and does not necessarily have to be connected to the same system as the system connected to the power generation facility E. However, it is desirable when the selected power generation facility is a power generation facility of a typical type in the market. It is also desirable when the selected power generation facility is of the same type as the type of the power generation facility E. For example, the selected power generation facility may be a simple cycle gas turbine. The power supply amount calculating unit 46 is configured to obtain parameter values of the selected power generation facility. The parameter values of the power generation facility in this situation are values of parameters other than the reference parameters and indicate capabilities having impact on the power supply, such as a maximum output (a maximum value of the power supply amount in a unit time period). The power supply amount calculating unit 46 may obtain the parameter values from an external server via the communication unit 24 or may obtain the parameter values stored in the storage unit 26 in advance.

The power supply amount calculating unit 46 is configured to calculate the power supply amount of the selected power generation facility in each time period, by performing an analysis while using the obtained parameter values, one obtained parameter group obtained by the reference parameter group obtaining unit 44, and the first contribution degree values obtained by the contribution degree obtaining unit 42. Because the power supply amount is considered to be an output value of the power generation facility, it is also possible to consider that the power supply amount calculating unit 46 calculates an operation pattern of the selected power generation facility in each time period (output fluctuation in each time period).

The power supply amount calculating unit 46 uses, as input conditions (boundary conditions), the price of the power per unit time period fluctuating as indicated by the first contribution degree obtained by the contribution degree obtaining unit 42, and also, the parameter value indicating the capability of the selected power generation facility forming one obtained parameter group together with the obtained parameter values. The power supply amount calculating unit 46 is configured to calculate the power supply amount in each time period within a predetermined length of time (e.g., one year) that was set with the first contribution degree, on the basis of an income (an earning) of the power generation facility which will be yielded when the selected power generation facility is operated under the input conditions. In the present embodiment, the power supply amount calculating unit 46 calculates the power supply amount in each time period so as to maximize the income from the power generation by the power generation facility when the selected power generation facility is operated under the input conditions. In other words, it is considered that the power supply amount calculating unit 46 calculates the power supply amount in each time period from the present time until the predetermined length of time elapses, so as to maximize the income from the power generation by the power generation facility, on the assumption that the price of the power fluctuates as indicated by the first contribution degree for the predetermined length of time from the present time and on the assumption that the power generation facility is operated under the conditions defined by the obtained parameter values and the obtained parameter group. In this situation, the income is a total of values each obtained by multiplying a price of the power per unit power amount by a supplied power amount.

From the obtained parameter values and the reference parameter groups, the power supply amount calculating unit 46 is able to calculate how the power generation facility is capable of operating, i.e., is able to calculate an operation pattern feasible by the power generation facility. Further, from the first contribution degree, the power supply amount calculating unit 46 is able to recognize the price of the power per unit time period. Accordingly, the power supply amount calculating unit 46 is able to calculate the power supply amount in each time period within the predetermined length of time, so as to maximize the income from the power generation by the power generation facility, on the basis of the obtained parameter values, the obtained parameter group, and the first contribution degree values. For example, the power supply amount calculating unit 46 calculates the power supply amount in each time period in such a manner that the higher is the price of the power in a time period, the larger is the power supply amount.

Further, in the present embodiment, there are a plurality of settings for the first contribution degree (i.e., the price of the power). The power supply amount calculating unit 46 determines which one of the plurality of first contribution degree values should be used, i.e., the amount of power to be supplied to each of the power markets M, at each of the different points in time and further calculates the power supply amount at each of the different points in time by using the first contribution degree determined for each of the power markets M. For example, when the price of the power is higher in the power market M2 at a given point in time, the power supply amount calculating unit 46 make larger the power supply amount to the power market M2 at the given point in time.

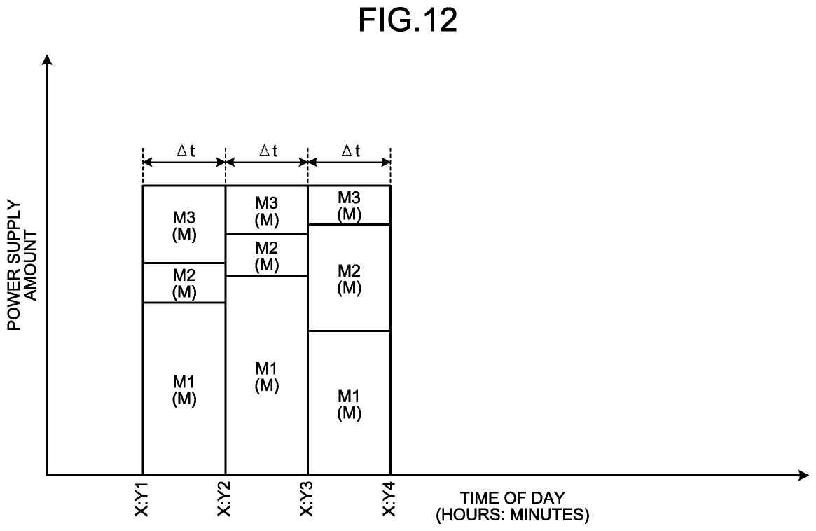

FIG. 12 is a graph illustrating examples of calculation values of the power supply amount in each time period. As illustrated in FIG. 12, the power supply amount calculating unit 46 is configured to calculate the power supply amount in each time period, so that the amount of power supplied in each time period fluctuates. Further, the power supply amount calculating unit 46 is configured to calculate the power supply amount in each time period, with respect to each of the power markets M. It should be noted, however, that the calculation value of the power supply amount in each time period illustrated in FIG. 12 is merely an example. For example, although the total value of the power supply amounts is equal among the different points in time in the example in FIG. 12, the total value may vary among the different points in time.

In the explanations above, the power supply amount calculating unit 46 is configured to calculate the power supply amount in each time period by using one of the plurality of reference parameter groups. Also, with respect to all the reference parameter groups, the power supply amount calculating unit 46 performs the same analysis to calculate a power supply amount in each time period, with respect to each of the reference parameter groups. In other words, the power supply amount calculating unit 46 performs the analysis explained above as many sessions as the number of reference parameter groups, by changing only the reference parameter group. Accordingly, the power supply amount in each time period is calculated with respect to each of the reference parameter groups, so that the power supply amount in each time period is different for each of the reference parameter groups.

The contribution degree calculating unit 48 illustrated in FIG. 6 is configured to calculate a second contribution degree on the basis of the power supply amount in each time period calculated by the power supply amount calculating unit 46. The second contribution degree is an index indicating a degree of contribution to stabilization of a system made by the power generation facility selected by the power supply amount calculating unit 46. The second contribution degree is an index different from the first contribution degree (the price of the power in the present example) and, in the present embodiment, indicates a profit to be yielded (an amount obtained by subtracting expenses from an income in the present example) when power is supplied by the power generation facility. On the basis of the power supply amount in each time period calculated by the power supply amount calculating unit 46 and the first contribution degree (i.e., the price of the power), the contribution degree calculating unit 48 calculates an income yielded by the power generation facility when supplying the power in the amount calculated by the power supply amount calculating unit 46. By multiplying the power supply amount in each time period by the price of the power of the time period, the contribution degree calculating unit 48 calculates an income for each time period and further calculates a total income by totaling the incomes of the time periods. The total income includes the incomes of all the power markets M. Further, the contribution degree calculating unit 48 calculates expenses to be incurred when power is supplied in the manner calculated by the power supply amount calculating unit 46. The expenses include labor costs, fuel costs for the power generation, and the like that will be incurred when power is supplied in the manner calculated by the power supply amount calculating unit 46. The contribution degree calculating unit 48 calculates a value obtained by subtracting the expenses from the total income, as the second contribution degree, i.e., the profit.

The power supply amount in each time period is calculated with respect to each of the reference parameter groups. The contribution degree calculating unit 48 is configured to calculate the second contribution degree, i.e., the profit, with respect to each of the reference parameter groups.

As explained above, the contribution degree calculating unit 48 is configured to calculate the profit to be yielded when power is supplied in the amount calculated by the power supply amount calculating unit 46, as the second contribution degree. In power markets, there is a tendency that the higher the degree of contribution to stabilization of a system is, the higher is the price of the power, and consequently, the larger is the profit. Accordingly, it is considered that the second contribution degree is the profit of the power generation facility, in other words. It should be noted, however, that the second contribution degree does not necessarily have to be the profit of the power generation facility, as long as the index indicates a degree of contribution to stabilization of the system and is calculated for each of the reference parameter groups. For example, the second contribution degree may be a total value of the incomes to be yielded by the power generation facility when supplying power in the amount calculated by the power supply amount calculating unit 46.

The calculation formula obtaining unit 30 according to the second embodiment is configured to set a calculation formula used for calculating a flexibility index FI on the basis of the second contribution degree. Although the calculation formula obtaining unit 30 sets the calculation formula of the flexibility index FI as presented in Expression (1) above, the coefficients K, i.e., weights to be applied to the reference parameters, are set on the basis of the second contribution degree.

The calculation formula obtaining unit 30 according to the second embodiment is configured, at first, to calculate magnitudes of change amounts in the second contribution degree to be caused when the reference parameter setting values are different and to further set the coefficients K on the basis of the result of the calculation. At first, the calculation of the magnitudes of the change amounts in the second contribution degree will be explained.

On the basis of the second contribution degree of each of the reference parameter groups, the calculation formula obtaining unit 30 according to the second embodiment calculates, for each of the reference parameters, a magnitude of the change amount in the second contribution degree to be caused when the reference parameter setting value is different. The calculation formula obtaining unit 30 may calculate the magnitude of the change amount in the second contribution degree by using all the possible combinations (e.g., 3⁵ combinations) of the reference parameter setting values, without reducing the number of combinations of the reference parameter setting values (the number of reference parameter groups). In this situation, from the contribution degree calculating unit 48, the calculation formula obtaining unit 30 obtains the second contribution degree values (the profits in the present example) with respect to all the possible combinations of the reference parameter setting values, i.e., all the reference parameter groups. Further, the calculation formula obtaining unit 30 calculates, for each of the reference parameters, the magnitude of the change amount in the second contribution degree to be caused when the reference parameter setting value is different, by performing a multiple regression analysis with respect to the second contribution degree of each of the combinations of the reference parameter setting values (the reference parameter groups). For example, the calculation formula obtaining unit 30 calculates a partial regression coefficient obtained by using the second contribution degree as a response variable and using the reference parameter setting value of each of the reference parameters as an explanatory variable, as the magnitude of the change amount in the second contribution degree to be caused when the reference parameter setting value is different. The multiple regression analysis described herein may be performed by using a publicly-known method.

When the magnitudes of the change amounts in the second contribution degree are calculated in this manner by using all the possible combinations of the reference parameter setting values, the calculation will cause a large load. To cope with this situation, the calculation formula obtaining unit 30 according to the second embodiment may calculate the magnitudes of the change amounts in the second contribution degree on the basis of an experimental design method, while reducing the number of combinations of the reference parameter setting values as illustrated in FIG. 11. With this arrangement, it is possible to reduce the calculation load because the number of combinations of the reference parameter setting values is reduced. In the following sections, a method for calculating the magnitudes of the change amounts in the second contribution degree based on an experimental design method will be explained.

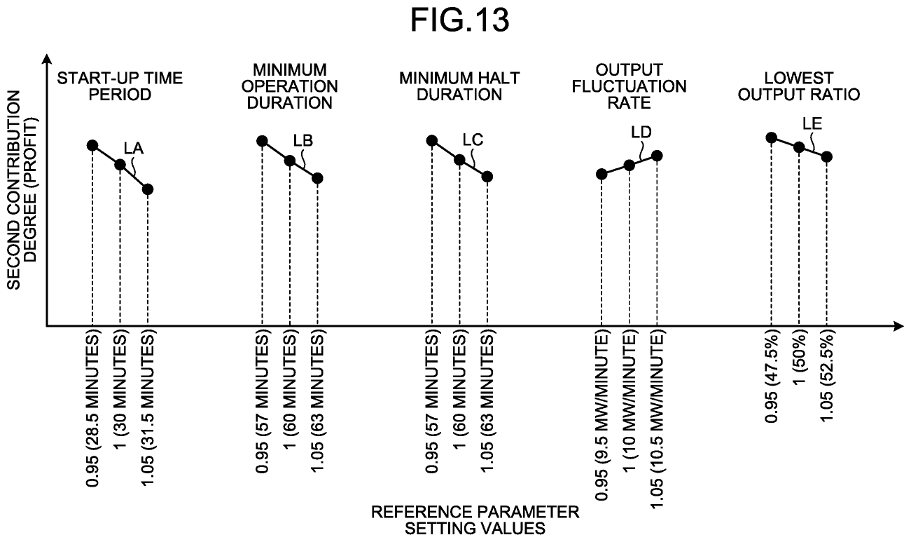

FIG. 13 is a graph illustrating examples of the magnitudes of the change amounts in the second contribution degree. When using an experimental design method, the calculation formula obtaining unit 30 obtains the combinations of the reference parameter setting values (the reference parameter groups) obtained by the reference parameter group obtaining unit 44, i.e., the combinations of reference parameter setting values (the reference parameter groups) of which the number of combinations has been reduced. Further, on the basis of the combinations of the reference parameter setting values (the reference parameter groups), the calculation formula obtaining unit 30 calculates the magnitudes of the change amounts in the second contribution degree to be caused when the reference parameter setting values are different. In other words, in this situation, the magnitudes of the change amounts in the second contribution to be caused when the reference parameter setting values are different serve as sensitivity to the reference parameter setting values.

In the example in FIG. 13, the calculation formula obtaining unit 30 calculates: a magnitude (a line segment LA) of the change amount in the second contribution degree to be caused when the reference parameter setting value of the start-up time period is different; a magnitude (a line segment LB) of the change amount in the second contribution degree to be caused when the reference parameter setting value of the minimum operation duration is different; a magnitude (a line segment LC) of the change amount in the second contribution degree to be caused when the reference parameter setting value of the minimum halt duration is different; a magnitude (a line segment LD) of the change amount in the second contribution degree to be caused when the reference parameter setting value of the output fluctuation rate is different; and a magnitude (a line segment LE) of the change amount in the second contribution degree to be caused when the reference parameter setting value of the lowest output ratio is different. The reference parameter setting values contained in the reference parameter groups are set in advance as illustrated in FIG. 11, for example, while the second contribution degree is calculated with respect to each of the reference parameter groups. Accordingly, by using a regression analysis on the basis of the second contribution degree of each of the reference parameter groups, the calculation formula obtaining unit 30 is able to calculate the magnitudes of the change amounts in the second contribution degree to be caused when the reference parameter setting values are different. In other words, the calculation formula obtaining unit 30 normalizes each of the reference parameter setting values in a predetermined numerical value range (0.95 to 1.05 in the example in FIG. 13) and calculates, for each of the reference parameters, the magnitude (sensitivity) of the change amount in the second contribution degree (i.e., each of the slopes in FIG. 13) to be caused when the normalized reference parameter setting value is different. In the example in FIG. 13, the magnitudes (sensitivities) of the change amounts in the second contribution degree to be caused when the reference parameter setting values are different become smaller and smaller in the order of: the start-up time period, the minimum operation duration, the output fluctuation rate, and the lowest output ratio, while the results of the minimum halt duration are the same as those of the minimum operation duration. Further, in the example in FIG. 13, for the output fluctuation rate, the values increase as the reference parameter setting values increase, unlike the other flexibility capabilities. It is observed, however, that the absolute value of the magnitude (the sensitivity) of the change amount is smaller than that of the minimum operation duration and is larger than that of the lowest output ratio.

As explained above, the calculation formula obtaining unit 30 is configured to calculate, for each of the reference parameters, the magnitude of the change amount in the second contribution degree, on the basis of the experimental design method. In that situation, the calculation formula obtaining unit 30 excludes a reference parameter having a small magnitude of the change amount in the second contribution degree, from the reference parameters to be used for the calculation of the flexibility index FI. The excluded reference parameter will not be set with a coefficient K and will be excluded from the calculation formula of the flexibility index FI presented in Expression (1). In other words, the calculation formula obtaining unit 30 may determine only such reference parameters of which the magnitude of the change amount in the second contribution degree is equal to or larger than a predetermined value, as the reference parameters to be used for the calculation of the flexibility index FI and does not have to use such a reference parameter of which the magnitude of the change amount in the second contribution degree is smaller than the predetermined value, as one of the reference parameters used for the calculation of the flexibility index FI. For example, in the example in FIG. 13, the lowest output ratio, which has a small magnitude of the change amount in the second contribution degree, may be excluded from the reference parameters to be used for the calculation of the flexibility index FI. When the reference parameter having a small magnitude of the change amount is excluded in this manner, because the number of parameters used for the calculation of the flexibility index FI is reduced, it is possible to make the flexibility index FI a refined and efficient index.

On the basis of the magnitudes of the change amounts in the second contribution degree to be caused when the reference parameter setting values are different, which were calculated as described above, the calculation formula obtaining unit 30 sets coefficients K. More specifically, the calculation formula obtaining unit 30 sets the coefficients K in such a manner that the larger change amount is to be caused in the second contribution degree of a reference parameter when the reference parameter setting value is different, the larger is the value of the coefficient K corresponding to the reference parameter. In other words, supposing that the reference parameter setting value are changed by the same ratio, such a reference parameter that will have a larger change amount in the second contribution degree is set with a larger coefficient K. Accordingly, when the magnitudes of the change amounts in the second contribution degree are calculated as illustrated in FIG. 13, the calculation formula obtaining unit 30 sets the values of the coefficients K so as to become smaller and smaller in the order of: the start-up time period, the minimum operation duration, the output fluctuation rate, and the lowest output ratio, while determining the coefficient K of the minimum halt duration to be equal to the coefficient K of the minimum operation duration. For example, the calculation formula obtaining unit 30 determines a coefficient K1 corresponding to the start-up time period to be 1; coefficients K2 and K3 corresponding to the minimum operation duration and the minimum halt duration, respectively, to be 0.9; a coefficient K4 corresponding to the output fluctuation rate to be 0.8; and a coefficient K5 corresponding to the lowest output ratio to be 0.7. It should be noted, however, that the numerical values of the coefficients K1, K2, K3, K4, and K5 are merely examples. It is acceptable as long as the coefficients K are set in such a manner that the larger change amount is to be caused in the second contribution degree of a flexibility capability when the reference parameter setting value is different, the larger is the value of the coefficient K corresponding to the flexibility capability. Further, in the present embodiment, the coefficients K are set within the range larger than 0 and equal to or smaller than 1; however, possible embodiments are not limited to this example. It is possible to set the coefficients K in an arbitrary numerical value range.

When the magnitudes of the change amounts in the second contribution degree have been calculated by using the experimental design method, and subsequently, the number of reference parameters has further been reduced by excluding such a reference parameter having a small magnitude of the change amount in the second contribution degree, the calculation formula obtaining unit 30 may re-calculate magnitudes of the change amounts in the second contribution degree. In that situation, for example, the calculation formula obtaining unit 30 obtains combinations of the reference parameter setting values (reference parameter groups) with respect to the remaining reference parameters that were not excluded and further calculates, for each of the remaining reference parameters that were not excluded, a magnitude of the change amount in the second contribution degree, by using the same or a similar method as described above (e.g., a regression analysis). The calculation formula obtaining unit 30 may set coefficients K by using the re-calculated magnitudes of the change amounts in the second contribution degree.

The calculation formula obtaining unit 30 determines the coefficients K in such a manner that the larger change amount is to be caused in the second contribution degree of a flexibility capability when the reference parameter setting value is different, the larger is the value of the coefficient K corresponding to the flexibility capability. Accordingly, it is considered that the calculation formula obtaining unit 30 is configured to set the calculation formula in such a manner that the larger change amount is to be caused in the second contribution degree when the reference parameter setting value is different, the larger weight is applied to the corresponding flexibility capability with respect to the flexibility index FI.

As explained above, the calculation formula obtaining unit 30 according to the second embodiment is configured to set the coefficient K with each of the flexibility capabilities, on the basis of the second contribution degree. Further, as presented in Expression (1), the calculation formula obtaining unit 30 is configured to set the calculation formula so that each of the parameter indices serving as variables is multiplied by the coefficient K set on the basis of the flexibility capability corresponding to the parameter index and so that the total value of the products in correspondence with the parameter indices (in correspondence with the flexibility capabilities) serves as the flexibility index FI. It should be noted, however, that the calculation formula set by the calculation formula obtaining unit 30 does not necessarily have to be the formula presented as Expression (1) in which the total value of the values (the products) each obtained by multiplying a parameter index by the corresponding coefficient K serves as the flexibility index FI. The calculation formula obtaining unit 30 may set a calculation formula, on the basis of values (products) that are in correspondence with the flexibility capabilities and are each obtained by multiplying a parameter index by a corresponding coefficient K. For example, the calculation formula obtaining unit 30 may obtain a flexibility index FI by multiplying the products of a parameter index and a coefficient K with one another, in correspondence with the reference parameters. Further, the calculation formula obtaining unit 30 does not necessarily have to set the calculation formula on the basis of the values (the products) each obtained by multiplying a parameter index by the corresponding coefficient K. The calculation formula obtaining unit 30 may set any calculation formula in which parameter indices corresponding to the reference parameters are used as variables, in such a manner that the larger change amount is to be caused in the second contribution degree when the reference parameter setting value is different, the larger weight is applied to the parameter index of the corresponding flexibility capability with respect to the flexibility index FI.

In this situation, the second contribution degree is a value indicating the degree of contribution to stabilization of the system. Consequently, according to the second embodiment, the larger change amount is to be caused in the second contribution degree of a reference parameter, the larger impact the reference parameter has on the flexibility index FI. As a result, the higher degree of contribution is to be made by a power generation facility to stabilization of the system, the larger is the flexibility index FI. Consequently, it is considered that the flexibility index FI also serves as a value quantitatively indicating the degree of contribution to stabilization of the system. Further, in the second embodiment, the first contribution degree denotes the price of the power in each of the power markets, whereas the second contribution degree denotes the profit. Consequently, it is also considered that the flexibility index FI is a value quantitatively indicating whether or not it is possible to properly supply power to power markets (e.g., real-time markets, ancillary service markets, etc.) requiring high operational flexibility, with respect to each of the markets or each of the regions while reflecting years or time periods. Furthermore, it is also considered that the flexibility index FI is a value quantitatively indicating whether or not it is possible to properly ensure profits.

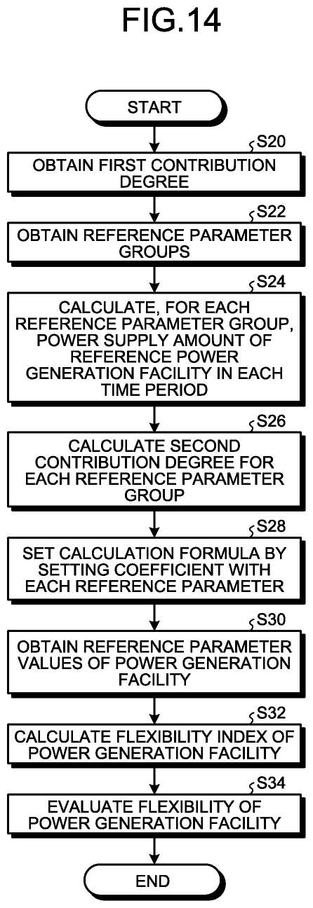

Next, a flow in the operational flexibility evaluating process for the power generation facility E according to the second embodiment will be explained, with reference to a flowchart. FIG. 14 is the flowchart for explaining the flow in the flexibility evaluating process for the power generation facility according to the second embodiment. As illustrated in FIG. 14, by employing the contribution degree obtaining unit 42, the evaluating device 10A, at first, obtains the first contribution degree (step S20). In the present embodiment, the contribution degree obtaining unit 42 obtains a plurality of values of the first contribution degree, and more specifically, obtains the price of the power per unit time period with respect to each of the power markets M. After having obtained the first contribution degree, the evaluating device 10A obtains the reference parameter groups by employing the reference parameter group obtaining unit 44 (step S22). Further, by employing the power supply amount calculating unit 46, the evaluating device 10A calculates, for each of the reference parameter groups, a power supply amount in each time period with respect to a reference power generation facility (a power generation facility other than the power generation facility E) (step S24). The power supply amount calculating unit 46 calculates the power supply amount in each time period so as to maximize the income from the power generation by the power generation facility. After that, by employing the contribution degree calculating unit 48, the evaluating device 10A calculates a second contribution degree with respect to each of the reference parameter groups, on the basis of the calculation value of the power supply amount in each time period (step S26). As the second contribution degree, the contribution degree calculating unit 48 calculates a profit that will be yielded when the power is supplied according to the calculation value of the power supply amount in each time period. Further, by employing the calculation formula obtaining unit 30, the evaluating device 10A sets a coefficient K with respect to each of the reference parameters on the basis of the second contribution degree, to set the calculation formula of the flexibility index FI (step S28). The calculation formula obtaining unit 30 sets the coefficients K in such a manner that the larger change amount is to be caused in the second contribution degree of a reference parameter, the larger is the value of the coefficient K corresponding to the reference parameter. The calculation formula obtaining unit 30 sets the calculation formula in which the parameter indices corresponding to the reference parameters serve as variables, while the coefficients K are constants. After having set the calculation formula, the evaluating device 10A obtains reference parameter values of the power generation facility E subject to an evaluation by employing the parameter value obtaining unit 32 (step S30) and calculates a flexibility index FI of the power generation facility E by inputting the reference parameter values of the power generation facility E to the calculation formula (step S32). By employing the flexibility evaluating unit 36, the evaluating device 10A evaluates operational flexibility of the power generation facility E, by using the flexibility index FI (step S34).

As explained above, in the second embodiment, the contribution degree obtaining unit 42 is configured to obtain the first contribution degree indicating the degree of contribution to stabilization of the system and being assigned to the power supply amount per unit time period. The reference parameter group obtaining unit 44 is configured to obtain the plurality of reference parameter groups each containing a plurality of types of reference parameter setting values. The power supply amount calculating unit 46 is configured to calculate, for each of the reference parameter groups, the power supply amount of the predetermined power generation facility in each time period, by performing the analysis on the basis of the reference parameter groups and the first contribution degree. The contribution degree calculating unit 48 is configured to calculate, for each of the reference parameter groups, the second contribution degree indicating the degree of contribution made by the predetermined power generation facility to stabilization of the system, on the basis of the power supply amount of the predetermined power generation facility (the reference power generation facility) in each time period. The calculation formula obtaining unit 30 is configured to set the calculation formula in such a manner that the larger change amount is to be caused in the second contribution degree of a reference parameter when the reference parameter setting value is different, the larger weight is applied with respect to the flexibility index FI. The evaluating device 10A is configured to calculate the flexibility index FI by using the calculation formula structured in such a manner that the larger change amount is to be caused in the second contribution degree of a flexibility capability when the reference parameter is different, the larger weight is applied with respect to the flexibility index FI. Consequently, the flexibility index FI serves as a quantitative value that comprehensively takes into account the capabilities having impact on the operational flexibility. By evaluating the operational flexibility of the power generation facility E while using the flexibility index FI calculated in this manner, the evaluating device 10A is able to properly evaluate the operational flexibility in response to a demand for power.

Further, for each of the reference parameters, the calculation formula obtaining unit 30 sets the coefficient K with which a value based on the reference parameter value (the parameter index in the present example) is multiplied, in such a manner that the larger change amount is to be caused in the second contribution degree of a flexibility capability when the reference parameter setting value is different, the larger is the value of the coefficient K. The evaluating device 10A is configured to calculate the flexibility index FI by using the coefficients K calculated in this manner. The evaluating device 10A is therefore able to more properly evaluate the capabilities having impact on the operational flexibility. It is thus possible to properly evaluate the operational flexibility of the power generation facility E.

Further, as the calculation formula, the calculation formula obtaining unit 30 sets the formula which adds together, in correspondence with the reference parameters, the values each obtained by multiplying a value based on the reference parameter value (the parameter index in the present example) by the corresponding one of the coefficients K. The evaluating device 10A is configured to calculate the flexibility index FI by using the calculation formula structured in this manner. The evaluating device 10A is therefore able to comprehensively evaluate the plurality of capabilities having impact on the operational flexibility. It is thus possible to properly evaluate the operational flexibility of the power generation facility E.

Further, the contribution degree obtaining unit 42 is configured to obtain the information about the first contribution degree with respect to each of the power markets M. The power supply amount calculating unit 46 is configured to calculate the power supply amount with respect to each of the power markets M. On the basis of the power supply amount of each of the power markets M, the contribution degree calculating unit 48 is configured to calculate the second contribution degree. The evaluating device 10A is therefore able to evaluate the operational flexibility while anticipating situations where power is supplied to the plurality of power markets M. Accordingly, the evaluating device 10 is able to properly evaluate the operational flexibility of the power generation facility E, even when power is supplied to the plurality of power markets M.

Further, as the first contribution degree, the contribution degree obtaining unit 42 is configured to obtain the price of the power set for each unit time period. On the basis of the price of the power set for each unit time period, the power supply amount calculating unit 46 is configured to calculate the power supply amount in each time period so as to maximize the income that will be yielded when power is supplied by operating a predetermined power generation facility while using the reference parameter groups. By using the prices of the power, the evaluating device 10A is configured to calculate the power supply amount in each time period that is used for setting the calculation formula, so as to maximize the income. Accordingly, the evaluating device 10A is configured to evaluate the operational flexibility of the power generation facility E from a viewpoint of incomes. It is therefore possible to properly evaluate the operational flexibility of the power generation facility E.

Further, as the second contribution degree, the contribution degree calculating unit 48 calculates the profit of the predetermined power generation facility that will be yielded when power is supplied in the power supply amount calculated by the power supply amount calculating unit 46. Accordingly, the evaluating device 10A is configured to use the profit as the second contribution degree used for setting the calculation formula. It is therefore possible to properly evaluate the operational flexibility of the power generation facility E from a viewpoint of profits.

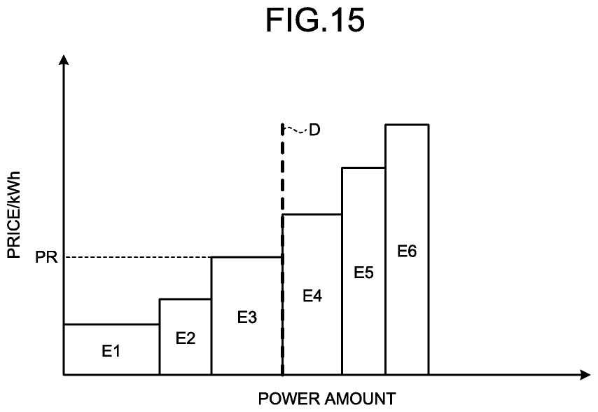

In the present embodiments, the contribution degree obtaining unit 42 is configured to obtain the values of the first contribution degree in the predetermined length of time from the past, as the first contribution degree. However, the contribution degree obtaining unit 42 does not necessarily have to use the past data as the first contribution degree and may calculate a first contribution degree in a predetermined length of time in the future. In that situation, for example, the contribution degree obtaining unit 42 may calculate the first contribution degree (the price of the power per unit time period in the present example), on the basis of a prediction value for a demanded power amount in the predetermined length of time in the future, a fuel cost in the predetermined length of time in the future, an external environment (weather changes) in the future, and the like. In that situation, for example, the contribution degree obtaining unit 42 may calculate a price of the power per unit time period, on the basis of a demanded power amount per unit time period, as well as power supply amounts and power costs of a plurality of power generation facilities in the unit time period. FIG. 15 is a graph illustrating an example of a method for setting the price of the power. In the example in FIG. 15, the horizontal axis expresses accumulated values of suppliable power amounts, whereas the vertical axis expresses the price of the power. The power cost of the power generation becomes higher and higher in the order of: power generation facilities E1, E2, E3, E4, E5, and E6. In the example in FIG. 15, the power supply amounts are accumulated starting with a power generation facility having a lower power cost, so that the power cost at the point when the accumulated power supply amount becomes equal to a demanded power amount (the line segment D) is set as the price of the power in the unit time period. However, the method for setting the price of the power described herein is merely an example. By using this method, it is possible to set the coefficients K even in a country or a region where no power markets are present, in the same manner as in a country or a region where power markets are present.

While certain embodiments of the present disclosure have been described, the description of the embodiments is not intended to limit the scope of the embodiments. Further, the constituent elements described above include those easily conceived of by a person skilled in the art and those that are substantially the same, which are in a so-called equivalent scope. Further, it is possible to combine any of the constituent elements described above as appropriate. Furthermore, various omissions, substitutions, and changes may be made to the constituent elements without departing from the gist of the embodiments described above.

### REFERENCE SIGNS LIST

1 EVALUATING SYSTEM
10 EVALUATING DEVICE
12 DETECTING DEVICE
28 CONTROL UNIT
30 CALCULATION FORMULA OBTAINING UNIT
32 PARAMETER VALUE OBTAINING UNIT
34 INDEX CALCULATING UNIT
36 FLEXIBILITY EVALUATING UNIT
42 CONTRIBUTION DEGREE OBTAINING UNIT
44 REFERENCE PARAMETER GROUP OBTAINING UNIT
46 POWER SUPPLY AMOUNT CALCULATING UNIT
48 CONTRIBUTION DEGREE CALCULATING UNIT
E POWER GENERATION FACILITY
FI FLEXIBILITY INDEX

1. A power generation facility evaluating device comprising:
a calculation formula obtaining unit that obtains a calculation formula used for calculating a flexibility index indicating operational flexibility in response to a demand for electric power, while using, as variables, a plurality of types of reference parameters which are parameters regarding flexibility capabilities of a power generation facility having impact on the operational flexibility in response to the demand for the electric power;
a parameter value obtaining unit that obtains a reference parameter value of each of the reference parameters with respect to a power generation facility subject to an evaluation;
an index calculating unit that calculates the flexibility index of the power generation facility subject to the evaluation, by inputting the reference parameter values obtained by the parameter value obtaining unit to the calculation formula; and
a flexibility evaluating unit that evaluates the operational flexibility of the power generation facility subject to the evaluation, on a basis of the calculated flexibility index, wherein
the calculation formula obtaining unit obtains the calculation formula set in such a manner that weights applied with respect to the flexibility index are different in correspondence with the types of reference parameters.

2. The power generation facility evaluating device according to claim 1, wherein the index calculating unit sets a plurality of parameter indices by dividing a possible numerical value range of each of the reference parameter values, into a plurality of numerical value range sections and assigning the parameter indices having mutually-different values to the numerical value range sections, respectively, and calculates the flexibility index by calculating the parameter index for each of the reference parameters and inputting the parameter indices to the calculation formula.

3. The power generation facility evaluating device according to claim 1, wherein the calculation formula obtaining unit obtains the calculation formula in which parameters relevant to a fluctuation speed of supplied electric power are used as the plurality of types of reference parameters, while a largest weight is applied to such a parameter among the plurality of types of reference parameters that has highest relevance to the fluctuation speed of the supplied electric power.

4. The power generation facility evaluating device according to claim 1, comprising:
a contribution degree obtaining unit that obtains a first contribution degree which indicates a degree of contribution to stabilization of a system and is assigned to a power supply amount per unit time period;
a reference parameter group obtaining unit that obtains a plurality of reference parameter groups each containing setting values of the plurality of types of the reference parameters;
a power supply amount calculating unit that calculates, for each of the reference parameter groups, a power supply amount of a predetermined power generation facility in each time period, by performing an analysis on a basis of the reference parameter groups and the first contribution degree; and
a contribution degree calculating unit that calculates, for each of the reference parameter groups, a second contribution degree indicating a degree of contribution made by the predetermined power generation facility to the stabilization of the system, on a basis of the power supply amount of the predetermined power generation facility in each time period, wherein
the calculation formula obtaining unit sets the calculation formula in such a manner that the larger change amount is to be caused in the second contribution degree of a reference parameter when the setting value of the reference parameter is different, the larger weight is applied to the reference parameter with respect to the flexibility index.

5. The power generation facility evaluating device according to claim 4, wherein
the calculation formula obtaining unit sets, for each of the reference parameters, a coefficient by which a value based on the reference parameter value is to be multiplied, and
the calculation formula obtaining unit sets the coefficients in such a manner that the larger change amount is to be caused in the second contribution degree of a reference parameter when the setting value of the reference parameter is different, the larger is a value of the coefficient of the reference parameter.

6. The power generation facility evaluating device according to claim 5, wherein the calculation formula obtaining unit sets, as the calculation formula, a formula that adds together, in correspondence with the operational capabilities, values each obtained by multiplying the value based on the reference parameter value by the coefficient.

7. The power generation facility evaluating device according to claim 4, wherein
the contribution degree obtaining unit obtains information about the first contribution degree with respect to each of electric power markets,
the power supply amount calculating unit calculates the power supply amount with respect to each of the electric power markets, and
the contribution degree calculating unit calculates the second contribution degree on a basis of the power supply amount of each of the electric power markets.

8. The power generation facility evaluating device according to claim 4, wherein
the contribution degree obtaining unit obtains a price of electric power that is set for each unit time period, as the first contribution degree, and
the power supply amount calculating unit calculates, on a basis of the price of the electric power set for each unit time period, the power supply amount in each time period, so as to maximize an income that will be yielded when electric power is supplied by operating the predetermined power generation facility while using the reference parameter groups.

9. The power generation facility evaluating device according to claim 8, wherein the contribution degree calculating unit calculates, as the second contribution degree, a profit of the predetermined power generation facility to be yielded when electric power is supplied in the calculated power supply amount.

10. The power generation facility evaluating device according to claim 1, wherein the reference parameters include at least one of: a start-up time period of the power generation facility; a minimum operation duration indicating a minimum time period during which the power generation facility needs to continue operating; a minimum halt duration indicating a time period during which the power generation facility needs to remain at a halt; an output fluctuation rate of the power generation facility; and a lowest output ratio of the power generation facility to a rated output.

11. A power generation facility evaluating system comprising:
the power generation facility evaluating device according to claim 1; and
a detecting device that is provided for the power generation facility and detects the plurality of reference parameter values of the power generation facility, wherein
the parameter value obtaining unit obtains the reference parameter values from the detecting device.

12. A power generation facility evaluating method executed by a computer comprising:
obtaining a calculation formula used for calculating a flexibility index indicating operational flexibility in response to a demand for electric power, while using, as variables, a plurality of types of reference parameters which are parameters regarding flexibility capabilities of a power generation facility having impact on the operational flexibility in response to the demand for the electric power;
obtaining a reference parameter value of each of the reference parameters with respect to a power generation facility subject to an evaluation;
calculating the flexibility index of the power generation facility subject to the evaluation, by inputting the obtained reference parameter values to the calculation formula; and
evaluating the operational flexibility of the power generation facility subject to the evaluation, on a basis of the calculated flexibility index, wherein
the obtaining the calculation formula includes obtaining the calculation formula set in such a manner that weights applied with respect to the flexibility index are different in correspondence with the types of reference parameters.

13. A computer program product having a non-transitory computer readable medium including programmed instructions, wherein the instructions, when executed by a computer, cause the computer to perform:
obtaining a calculation formula used for calculating a flexibility index indicating operational flexibility in response to a demand for electric power, while using, as variables, a plurality of types of reference parameters which are parameters regarding flexibility capabilities of a power generation facility having impact on the operational flexibility in response to the demand for the electric power;
obtaining a reference parameter value of each of the reference parameters with respect to a power generation facility subject to an evaluation;
calculating the flexibility index of the power generation facility subject to the evaluation, by inputting the obtained reference parameter values to the calculation formula; and
evaluating the operational flexibility of the power generation facility subject to the evaluation, on a basis of the calculated flexibility index, wherein
the obtaining the calculation formula includes obtaining the calculation formula set in such a manner that weights applied with respect to the flexibility index are different in correspondence with the types of reference parameters.
